(19) United States
(12) Patent Application Publication
(10) Pub. No.: US 2017/0233177 A1
(43) Pub. Date: Aug. 17, 2017

(54) BRAN-TEA SYSTEMS

(71) Applicants: Deokee Shaw, Scarborough (CA); Jaimalla Singh, Scarborough (CA)

(72) Inventors: Deokee Shaw, Scarborough (CA); Jaimalla Singh, Scarborough (CA)

(21) Appl. No.: 15/043,664

(22) Filed: Feb. 15, 2016

(51) Int. Cl. B65D 85/808; A23F 3/14; A23F 3/40

(52) U.S. Cl. CPC B65D 85/808; A23F 3/405; A23F 3/14

(57) ABSTRACT

A bran-tea system for consumption of a non-alcoholic beverage whenever an alcoholic beverage is desired. The bran-tea system permits an individual the ability to experience the taste of an alcoholic brandy tea mixture without the effects caused by alcohol. The bran-tea system uses a mixture of chamomile, honey, and a non-alcoholic brandy flavoring to achieve the taste of a hot brandy drink. The bran-tea mixture taste increases in strength the longer the tea is allowed to steep in a teacup with heated water.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### FIELD OF THE INVENTION

The present invention relates generally to the field of brewed drinks and more specifically relates to a bran-tea system.

### DESCRIPTION OF RELATED ART

Many individuals enjoy flavored drinks. Some of these flavored drinks include tea, coffee, hot chocolate, milkshakes, soda, juice, beer, and bottled spirits. Combining of two or more flavored drinks has become a delightful alternative to experience a new flavor. The combination differs depending on the age group of the individual. One such popular mixture is tea blended with different ingredients. The addition of alcoholic beverages to certain drinks is often used as a diversion from a hard day's work.

Blending tea and alcohol together is one very popular choice for retirees, but not limited exclusively to this group. Often, the individual mixes tea with rum, whiskey, brandy and the like. Mixing in these alcoholic beverages enhances the flavor of the tea; however, there is a side effect of becoming inebriated. Inebriated individuals are at risk of injuring themselves and others. Furthermore, any illnesses may be exacerbated by imbibing alcohol. It is therefore desirable to have a non-alcoholic flavored tea mixture.

Several attempts have been made to solve the above-mentioned problems such as those found in U.S. Pub. No. 2014/0295049 to Philippe Ragot et al., 2004/0255788 to Graham Bowe, and 2006/0228431 to David Eben et al.; U.S. Pat. No. 6,287,567 to Dorothy J. Blount; foreign Pat and Pub Nos CN104705449 to Luan Yang, CN103141645 to Yao, CN101926396 to Zhao Baoyun, CN103609791 to Anhui Borg Biotechnology Co., Ltd., CN103125665 to Tang Hanzhong, and WO2010139660 to Manfred Engels. This art is representative of bran-tea. However, none of the above inventions and patents, taken either singly or in combination, is seen to describe the invention as claimed.

Preferably, a bran-tea should provide a means for individuals to experience the taste of a hot brandy tea drink with no alcohol or side effects thereof and, yet would operate reliably and be manufactured at a modest expense. Thus, a need exists for a reliable bran-tea system to avoid the above-mentioned problems.

### BRIEF SUMMARY OF THE INVENTION

In view of the foregoing disadvantages inherent in the known brewed drink art, the present invention provides a novel bran-tea. The general purpose of the present invention, which will be described subsequently in greater detail is to provide a brandy flavored tea drink with no alcohol or side effects thereof.

A bran-tea system is disclosed herein, in a preferred embodiment, comprising: a bran-tea composition comprising; an infusible bag comprising, a chamomile plant material, a honey natural sweetener, and a non-alcoholic brandy flavoring ingredient. The bran-tea system comprises the bran-tea composition, and the bran-tea composition comprises in functional combination the infusible bag, the chamomile plant material, the honey natural sweetener, and the non-alcoholic brandy flavoring ingredient. The bran-tea composition admixture comprises non-habit forming, non-alcoholic brandy flavored ingredients which provides a means for a non-alcoholic brandy flavored tea. Other mixtures of the mentioned constituents may be used in alternate embodiments.

The bran-tea system uses the infusible bag to contain the chamomile plant material, the honey natural sweetener, and the non-alcoholic brandy flavoring ingredient. When the infusible bag is placed in a cup of heated water, the steeping process begins. The user may then choose the duration of time the infusible bag should steep. Once the tea has reached the desired flavor, the infusible bag is removed and discarded.

A method of providing a bran-tea system is also disclosed herein comprising the steps of: providing a bran-tea composition in the infusible bag comprising; a chamomile plant material, a honey natural sweetener, and a non-alcoholic brandy flavoring ingredient. The method further comprises the step of admixing the chamomile plant material, the honey natural sweetener, the non-alcoholic brandy flavoring ingredient, and the non-habit forming ingredients to produce the bran-tea composition.

The present invention holds significant improvements and serves as a bran-tea. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, bran-tea systems, constructed and operative according to the teachings of the present invention.

FIG. 1 shows a perspective view illustrating a bran-tea system during an ‘in-use’ condition showing a user drinking the bran-tea admixture according to an embodiment of the present invention.

FIG. 2 is a perspective view illustrating the bran-tea system comprising a user inserting a bran-tea bag into a teacup according to an embodiment of the present invention of FIG. 1.

FIG. 3 is a perspective view illustrating the bran-tea system steeping in a teacup with heated water according to an embodiment of the present invention of FIGS. 1-2.

FIG. 4 is a perspective view illustrating the bran-tea system broken down into the core components according to an embodiment of the present invention of FIGS. 1-3.

FIG. 5 is a flowchart illustrating a method of use for the bran-tea system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a brewed drink and more particularly to a bran-tea system as used to improve the taste of brandy flavored tea without the alcohol.

Generally speaking, a tea bag containing honey, chamomile, and a non-alcoholic brandy flavor will simulate the taste of brandy without including the negative effects of a true alcoholic beverage. The non-alcoholic brandy tea may be enjoyed by seniors, those who chose not to drink alcohol, and for those who would like to enjoy the taste of brandy throughout the day or those who plan to drive without the alcohol content.

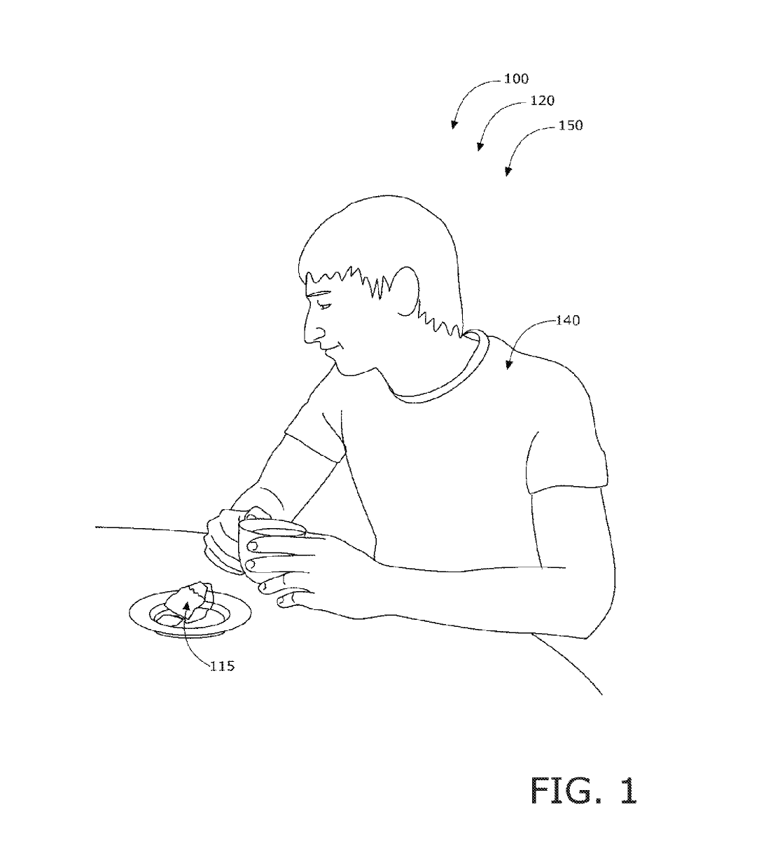

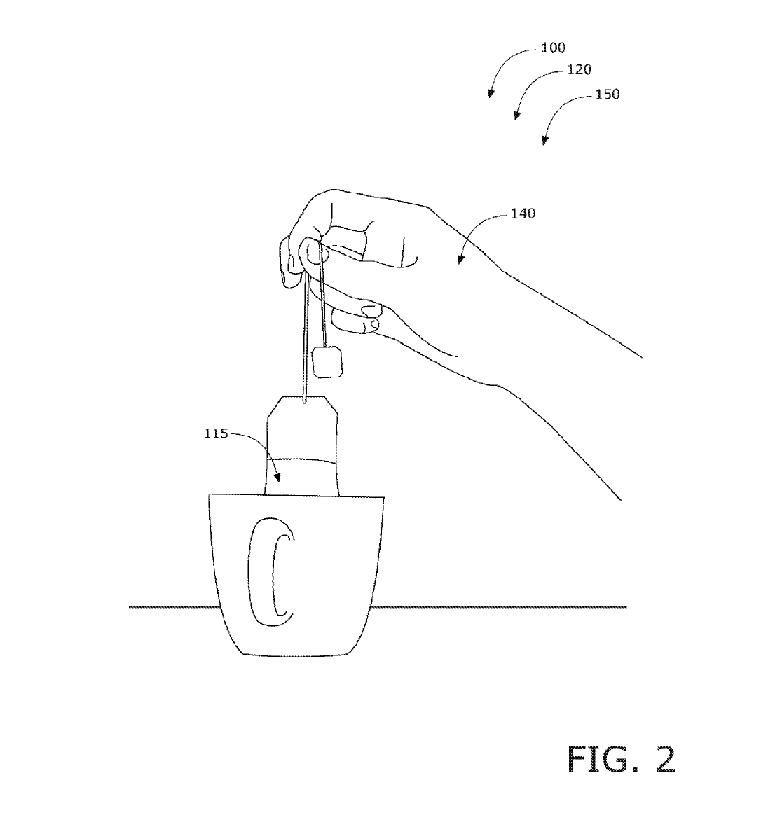

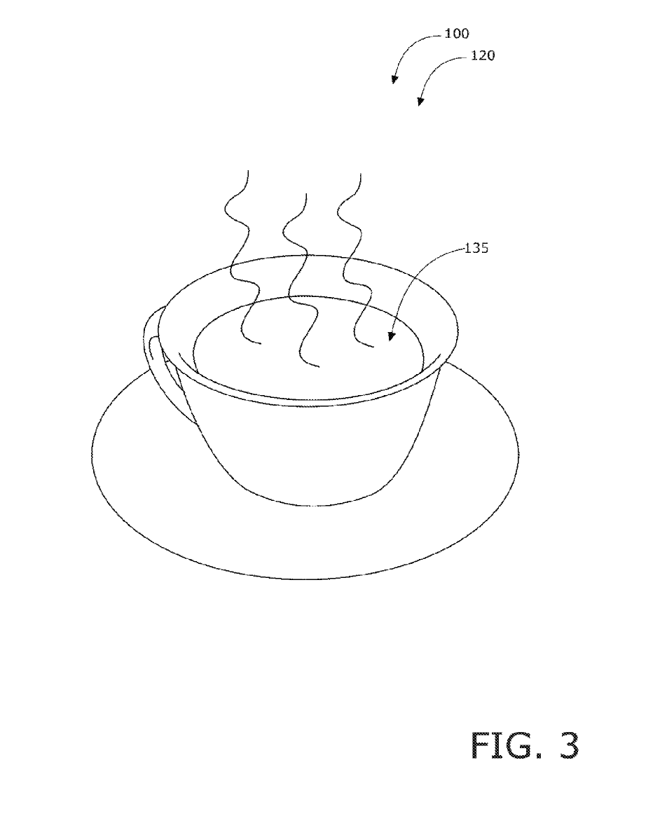

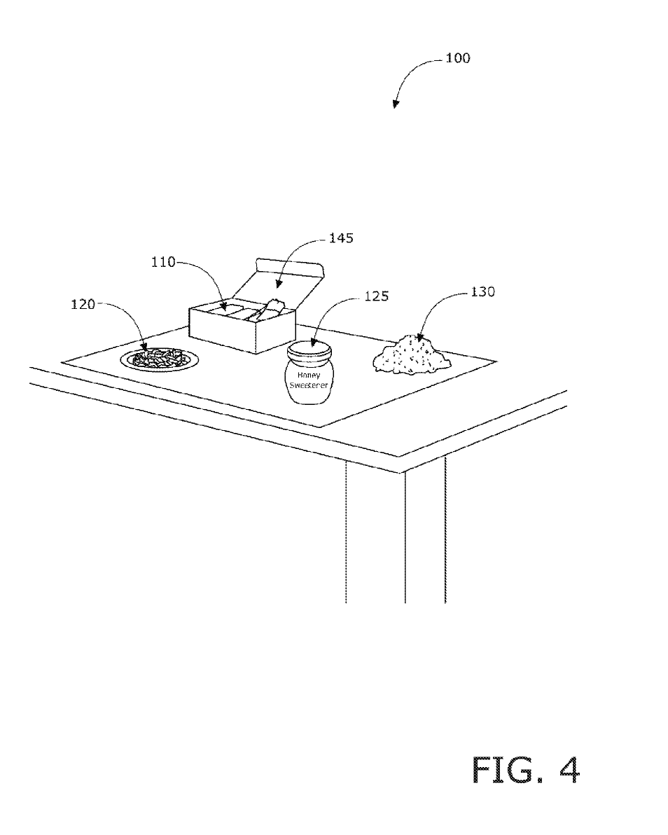

Referring to the drawings by numerals of reference there is shown in FIGS. 1-4, bran-tea system 100 in a preferred embodiment comprises: bran-tea composition 110 comprising infusible bag 115 comprising chamomile plant material 120, honey natural sweetener 125, and non-alcoholic brandy flavoring ingredient 130. Bran-tea composition 110 comprises in functional combination infusible bag 115 comprising chamomile plant material 120, honey natural sweetener 125, and non-alcoholic brandy flavoring ingredient 130. Bran-tea composition 110 creates an admixture and therefore is suitably mixed to provide a means for a non-alcoholic brandy flavored tea 135. Bran-tea composition 110 may further comprise non-habit forming ingredients. Bran-tea composition 110 may be distributed in a tea box 145 containing a plurality of infusible bags 115.

Alcoholic beverages are destructive to the human body. The effects of alcohol are well known and documented. Some of the more serious effects are cirrhosis of the liver, stroke, heart attack, and in some rare cases alcohol poisoning which may lead to death. It is often desired to have the alcoholic taste without the harmful effects. Bran-tea system 100 allows an individual to enjoy a non-alcoholic brandy flavoring ingredient 130 when combined with chamomile plant material 120, and honey natural sweetener 125 forms the bran-tea composition 110 which then satisfies the craving for an alcoholic beverage.

The benefit of non-alcoholic mixtures provides a way to alleviate the desire for alcohol by permitting an individual the ability to drink a significant amount without the negative effects of traditional bottled spirits. Bran-tea system 100 using a combined composition of the ingredients chamomile plant material 120, honey natural sweetener 125, and non-alcoholic brandy flavoring ingredient 130, contained in the infusible bag 115, may be placed into a teacup containing heated water to begin the steeping process. The longer infusible bag 115 is allowed to steep, the stronger the bran-tea will taste. Once the bran-tea has reached the desired taste of the user 140, infusible bag 115 is then discarded. The present invention may or may not comprise the mentioned ingredients and are considered to fall within the scope of the present disclosure when providing a non-alcoholic or alcoholic tea mixture for consumption.

Bran-tea system 100 may be sold as kit 440 comprising the following parts: at least one tea box 145, at least one infusible bag 115; and at least one set of user instructions. The kit has instructions such that functional relationships are detailed in relation to the structure of the invention (such that the invention can be used, maintained, or the like in a preferred manner). Bran-tea system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different ingredient combinations, parts may be sold separately, etc., may be sufficient.

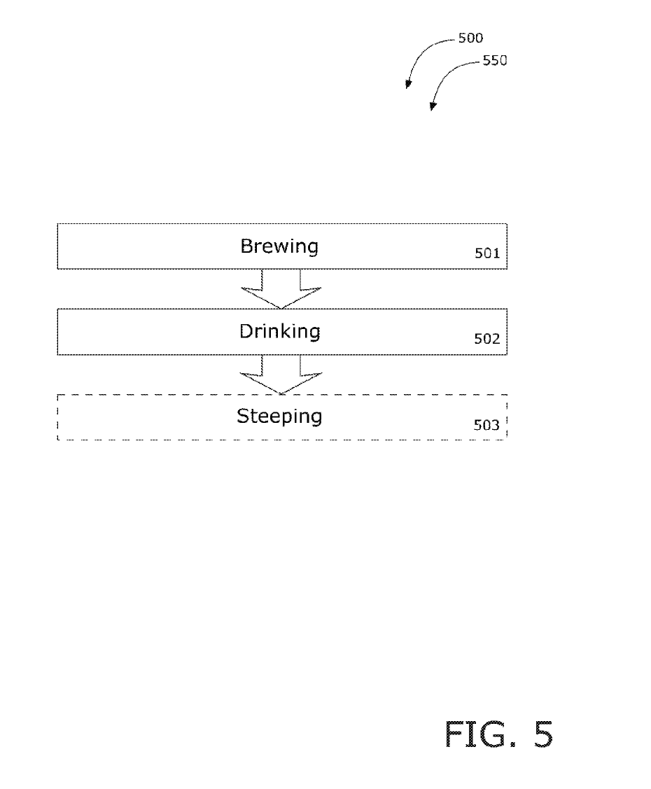

Referring now to FIG. 5 showing flowchart 550 illustrating method of use 500 for bran-tea system 100 according to an embodiment of the present invention of FIGS. 1-4. As shown, method of use 500 may comprise the steps of: step one 501, brewing the tea; step two 502, drinking the brewed tea; and step three 503, steeping to desired taste.

It should be noted that step 503 is an optional step and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1) A bran-tea system comprising:
a) a bran-tea composition, not comprising tea plant material, comprising;
i) an infusible bag comprising;
bran;
a chamomile plant material;
a sweetener; and
a non-alcoholic brandy flavoring ingredient;
b) wherein said bran-tea system comprises said bran-tea composition;
c) wherein said bran-tea composition comprises in functional said infusible bag comprising said chamomile plant material, said honey natural sweetener, and said non-alcoholic brandy flavoring ingredient; and
d) wherein said bran-tea composition creates an admixture suitable to provide a means for providing a non-alcoholic brandy flavored tea.

2) The bran-tea system of claim 1 wherein said chamomile plant material comprises black tea and said sweetener comprises a honey natural sweetener.

3) The bran-tea system of claim 1 wherein said chamomile plant material comprises white tea.

4) The bran-tea system of claim 1 wherein said chamomile plant material comprises green tea.

5) The bran-tea system of claim 1 wherein said chamomile plant material is decaffeinated.

6) The bran-tea system of claim 1 wherein said honey natural sweetener comprises cane sugar.

7) The bran-tea system of claim 1 wherein said honey natural sweetener comprises corn syrup.

8) The bran-tea system of claim 1 wherein said honey natural sweetener comprises agave nectar.

9) The bran-tea system of claim 1 wherein said honey natural sweetener comprises maple syrup.

10) The bran-tea system of claim 1 wherein said honey natural sweetener comprises beet sugar.

11) The bran-tea system of claim 1 wherein said honey natural sweetener comprises coconut sugar.

12) The bran-tea system of claim 1 wherein said non-alcoholic brandy flavoring comprises cognac.

13) The bran-tea system of claim 1 wherein said non-alcoholic brandy flavoring comprises kappa pisco.

14) The bran-tea system of claim 1 wherein said non-alcoholic brandy flavoring comprises merlet saint sauvant.

15) The bran-tea system of claim 1 wherein said non-alcoholic brandy flavoring comprises comandon xo cognac.

16) The bran-tea system of claim 1 wherein said bran-tea composition comprises only non-habit forming ingredients and not comprising alcohol and caffeine.

17) A bran-tea system comprising:
a) a bran-tea composition, not comprising tea plant material, comprising;
i) an infusible bag comprising;
bran;
a chamomile plant material;
a honey natural sweetener; and
a non-alcoholic brandy flavoring ingredient;
b) wherein said bran-tea system comprises said bran-tea composition;
c) wherein said bran-tea composition comprises in functional combination, said infusible bag comprising said chamomile plant material, said honey natural sweetener, and said non-alcoholic brandy flavoring ingredient; and
d) wherein said bran-tea composition creates an admixture suitable to provide a means having for a non-alcoholic brandy flavored tea; and
e) wherein said bran-tea composition comprises non-habit forming ingredients.

18) A method of providing a bran-tea system of claim 17 comprising the steps of:
a) providing said bran-tea composition in said infusible bag comprising;
i) said chamomile plant material;
ii) said honey natural sweetener; and
iii) said non-alcoholic brandy flavoring ingredient; and
b) admixing said chamomile plant material, said honey natural sweetener, and said non-alcoholic brandy flavoring ingredient as said admixture for drinking.

19) The method of providing a bran-tea system of claim 18 wherein said bran-tea composition comprises non-habit forming ingredients.
